(19) United States
(12) Patent Application Publication
(10) Pub. No.: US 2025/0214863 A1
(43) Pub. Date: Jul. 3, 2025

(54) METHODS OF PRODUCING CATHODE MATERIAL PRECURSORS UTILIZING CAVITATION, AND PRODUCTS THEREOF

(71) Applicant: Tesla, Inc., Austin, TX (US)

(72) Inventors: Feng Zou, Burlington (CA); Sungjong Lee, Toronto (CA); Yang Liu, Oakville (CA); Mohammad Jahangir Hossain, Mississauga (CA); Hongyang Li, Oakville (CA); Quanmin Yang, Brampton (CA); Michael Austin Mardock, Pflugerville, TX (US); Jonathan Alan Van Regenmorter, Pflugerville, TX (US)

(21) Appl. No.: 18/824,696

(22) Filed: Sep. 4, 2024

Related U.S. Application Data
(60) Provisional application No. 63/616,162, filed on Dec. 29, 2023.

(51) Int. Cl. C01G 53/00; H01M 4/48

(52) U.S. Cl. CPC C01G 53/82; H01M 4/48; C01P 2002/22; C01P 2002/72; C01P 2004/61; C01P 2006/11; C01P 2006/40; H01M 2220/20

(57) ABSTRACT

A process for the production of a mixed metal hydroxide material for use as a cathode active material precursor is described, wherein the process utilizes cavitation to produce high quality materials through elimination of some processing steps and ingredients. In particular, a method of producing a mixed metal hydroxide material combining a first metal, a second metal, an oxidant and a liquid to form a reaction slurry is disclosed. The method may include applying cavitation to the liquid prior to the formation of the reaction slurry and/or applying cavitation to the liquid when the liquid is part of the reaction slurry. A method of forming an active material and a mixed metal hydroxide material for use as an active material precursor is also disclosed.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims the priority benefit under 35 U.S.C. § 119 (e) to U.S. Provisional Patent Application No. 63/616,162, filed Dec. 29, 2023, entitled “METHODS OF PRODUCING CATHODE MATERIAL PRECURSORS UTILIZING CAVITATION, AND PRODUCTS THEREOF”, the content of which is hereby expressly incorporated by reference in its entirety.

### BACKGROUND

### Field

This invention relates to methods for producing cathode material precursors for energy storage devices, and products thereof. In particular, the provided method relates to producing cathode material precursors utilizing cavitation.

### Description of the Related Art

Rechargeable energy storage devices have been used in various electronic systems including mobile phones, portable computers, wireless power tools, hybrid and electric vehicles, and the like for many years. Recently, to help mitigate climate change and reduce carbon manufacturing footprints, the demand for higher-output energy storage devices for electric vehicles has increased dramatically.

Some components used for production of an energy storage devices includes anodes, cathodes, and electrolyte. During operation of an energy storage device (i.e., during charge and discharge cycles), ions are shuttled between the anode and cathode active materials through the electrolyte. In such energy storage devices, the cathode active material is usually the most expensive component due to the energy storage devices' limited specific-capacity and its high cost of production and raw materials, Therefore, the proper selection of the cathode active material can improve the performance of, and lower the cost, of energy storage devices.

Currently, lithium mixed metal oxides, which may contain nickel, cobalt, manganese, and/or aluminum with other necessary dopants, are the main components used for the production of cathode active materials for energy storage devices. Incumbent industrial methods to produce these high performance cathode materials, such as lithium mixed metal oxides, may include an oxidized metal, or a mixed metal hydroxide precursor production step and a lithiation step.

### SUMMARY

For purposes of summarizing the invention and the advantages achieved over the prior art, certain objects and advantages of the invention are described herein. Not all such objects or advantages may be achieved in any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

In one aspect, a method of producing a mixed metal hydroxide material is described. The method includes: combining a first metal, a second metal, an oxidant and a liquid to form a reaction slurry; applying cavitation to the reaction slurry; and reacting the first metal, the second metal and the oxidant to form a product slurry comprising a mixed metal hydroxide material; wherein the mixed metal hydroxide material comprises the first metal and the second metal; and wherein the first metal and the second metal are different metals.

In some embodiments, the cavitation is applied to the liquid prior to the formation of the reaction slurry. In some embodiments, the cavitation is applied to the liquid when the liquid is part of the reaction slurry. In some embodiments, the cavitation is applied by a device selected from the group consisting of an ultrasonic device, a hydrodynamic cavitation device, and combinations thereof.

In some embodiments, the reaction slurry does not comprise a seed mixed metal hydroxide material. In some embodiments, the mixed metal hydroxide comprises less than 10% of a layered double hydroxide (LDH) phase. In some embodiments, the mixed metal hydroxide material comprises a tapped density of at least 1 g/cm³. In some embodiments, the mixed metal hydroxide material comprises a SPAN of at most about 2 in particle size distribution value. In some embodiments, the mixed metal hydroxide material is substantially free of a nitrate impurity. In some embodiments, the mixed metal hydroxide material is substantially free of a sulfate or sulfur impurity.

In some embodiments, the reaction slurry comprises a pH of at least about 7. In some embodiments, the first metal is selected from the group consisting of nickel, manganese, cobalt, aluminum, magnesium and combinations thereof. In some embodiments, the second metal is selected from the group consisting of nickel, manganese, cobalt, aluminum, magnesium, zirconium, yttrium, titanium, vanadium, molybdenum and combinations thereof. In some embodiments, the oxidant is selected from the group consisting of oxygen, air comprising oxygen, nitric acid, hydrogen peroxide, and combinations thereof. It should be realized that when nitric acid is used as the oxidant, the actual oxidation may be carried out by nitrate. Nitric acid is converted to nitrate in alkaline liquids, such as found within a reactor using the present process. In some embodiments, nitric acid may be used directly. Alternatively, metal nitrate (first metal or second metal nitrate) may be used to replace part of the nitric acid used in the process. Further, ammonium nitrate may be also used as oxidizer in the present process in some embodiments.

In some embodiments, the method further comprises isolating the mixed metal hydroxide material from the reaction slurry and thereby forming a product slurry and a returning slurry. In some embodiments, the method further comprises separating the product slurry to form a mixed metal hydroxide product and a filtrate liquid. In some embodiments, the method further comprises recombining the filtrate liquid with the reaction slurry. In some embodiments, the returning slurry comprises at least one of the first metal and the second metal, wherein the first and second metals of the returning slurry do not substantially comprise a coating.

In another aspect, a method of forming an active material is described. The method includes: performing a method of producing a mixed metal hydroxide material; forming a final mixture comprising the mixed metal hydroxide material and a lithium source; and calcining the final mixture thereby forming an active material.

In another aspect, a mixed metal hydroxide material for use as an active material precursor is described. The mixed metal hydroxide material includes: a first metal; a second metal; and a tapped density of at least 1 g/cm³; wherein the first metal and the second metal are different metals; and wherein the mixed metal hydroxide material comprises less than 10% of a layered double hydroxide (LDH) phase.

In some embodiments, the mixed metal hydroxide material is selected from a metal oxide, a metal hydroxide, and combinations thereof.

### BRIEF DESCRIPTION OF THE DRAWINGS

FIG. 1 is a flowchart showing a method of producing a mixed metal hydroxide material according to some embodiments.

FIG. 2 is an X-ray diffraction (XRD) spectra of a mixed metal hydroxide material, according to some embodiments.

FIG. 3 is a plot chart showing the metal activity over time of a reaction for producing a mixed metal hydroxide material utilizing cavitation, according to some embodiments, in comparison to a comparative reaction without cavitation.

FIG. 4 is an X-ray diffraction (XRD) spectra of a comparative mixed metal hydroxide material.

FIG. 5 is a plot chart showing the particle size distributions over time of a reaction for producing a mixed metal hydroxide material utilizing cavitation, according to some embodiments.

It will be clearly understood though, that the examples and figures are for illustrative purpose only, and are not necessarily restrictive of the scope of the present invention.

### DETAILED DESCRIPTION

Although certain preferred embodiments and examples are disclosed below, the inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations, in turn, in a manner that may be helpful in understanding certain embodiments; however, the order of description should not be construed to imply that these operations are order-dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Incumbent industrial processes to produce high-performance electrode materials (e.g., cathode active material precursors), such as lithium mixed metal oxides, include two main steps. The first step is a precursor production step, and the second step is a lithiation step. The precursor step starts by dissolving mixed metal sulphates in water to form an aqueous solution. The precursor is then produced through a co-precipitation process with sodium hydroxide. However, these conventional processes can release a significant amount of undesirable effluent and/or release solid waste with effluent treatment.

To further improve the product quality as well as to further improve process control, the present application applies cavitation into the reaction system, which can be used for environmentally friendly processes to help reduce greenhouse gas emissions for the production of energy storage devices, such as for electric vehicles.

A process for the production of a mixed metal hydroxide material for use as a cathode active material precursor is described, wherein the process utilizes cavitation. It was found that the use of cavitation during the synthesis of mixed metal hydroxide materials produces high quality materials and/or reduces or eliminates the need for some processing steps and/or ingredients. In some embodiments, such a cavitation process may be utilized in a process that does not or does not substantially generate effluent, and therefore does not or does not substantially generate waste product and/or wherein the waste product may be recycled.

As used herein, the term, “cavitation” refers to the formation and collapse of partial vacuums (e.g., small vapor-filled cavities, vapor pockets, bubbles, etc.) based on pressure fluctuations in a liquid. Cavitation may be used to enhance chemical reactions or propagate certain unexpected reactions due to free radicals that are generated during disassociation of vapors trapped in the cavities.

In some embodiments, cavitation may affect the morphology of material surfaces, the shape of primary particles (e.g., mixed metal hydroxide particles), prevent phase formation (e.g., the formation of a double layered hydroxide phase in a mixed metal hydroxide material), prevent the formation of a coating on an unreacted raw materials (e.g., metallic metals), reduce impurities of precursor products, and control particle size distributions, including generation of fines and particle growth rates.

As used herein, the term “solution” may mean a liquid that includes a solvent and a solute. In some cases, the solvent may be a liquid such as water, and the solute may be either another liquid, such as alcohol, or a solid such as a salt. Once the solute is dissolved in the solvent, the resultant solution is a liquid.

As used herein the term “slurry” may mean a composition having a liquid, a solid, and gas phase. This type of slurry may contain reactant metals, a reactant oxidant (either as liquid such as nitrate or hydrogen peroxide or a gas such as oxygen), the solid, and a liquid. In some embodiments, the slurry contains all the reactants and products. The slurry is still a type of fluid as it flows. The liquid phase may contain a solvent (water), cations and anions, so itself can be a solution.

### Cavitation Process of Forming a Mixed Metal Hydroxide

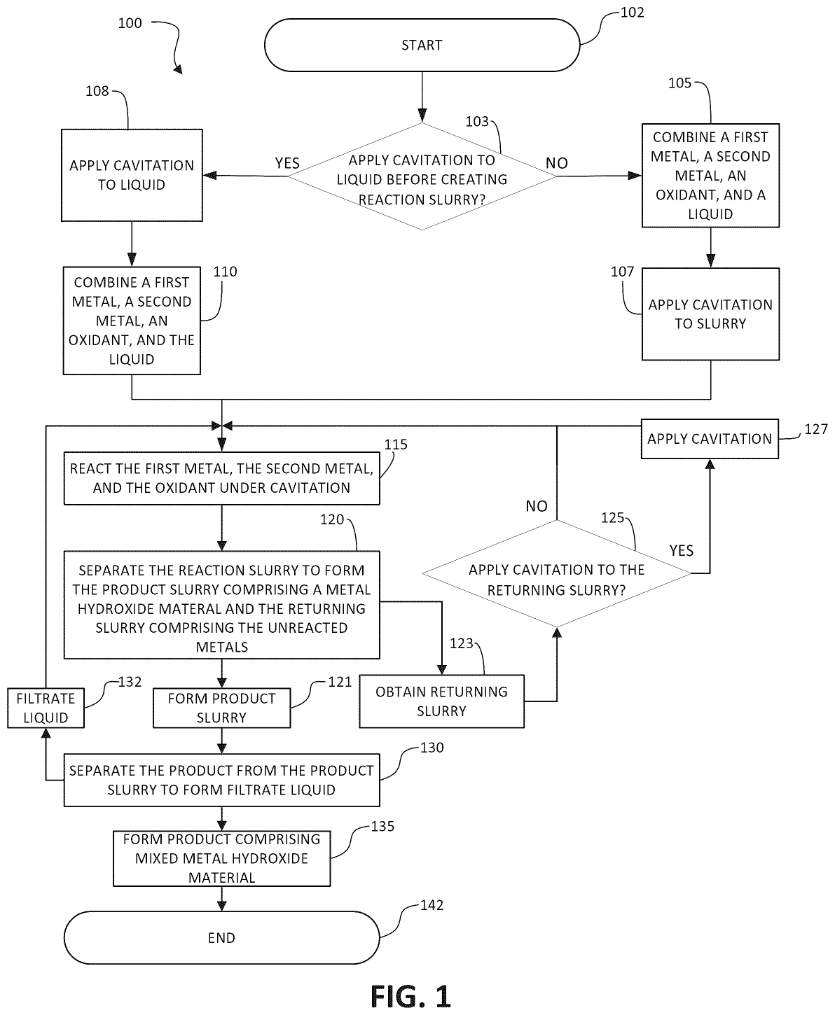

The mixed metal hydroxide material is formed as a product of an oxidation process comprising cavitation. FIG. 1 is a flowchart showing one method of producing a mixed metal hydroxide material according to some embodiments. The process 100 begins at a start step 102 and then moves to a decision step 103 to determine if the cavitation will be performed on the liquid prior to, during, or after, the other components of the reaction mixture are combined. It should be realized that the cavitation process may be performed on the liquid before it is combined with the metal. Alternatively, the cavitation process may be performed while the metal components are being used to form the reaction slurry. Additionally, the cavitation process may be performed after the metal has been added to the liquid.

As shown in FIG. 1, a determination is made at the decision step 103 whether or not to apply cavitation to the liquid. If a determination is made to not perform cavitation, the process 100 moves to a step 105 of combining a first metal, a second metal, an oxidant and a liquid. Once the materials are combined, the process 100 moves to a step 107 of applying cavitation to the mixture or the slurry. The cavitation shall continue in step 115 to react the first metal, the second metal, and the oxidant. The cavitation may be performed continuously, or intermittingly. In one embodiment, cavitation by sonication may be performed intermittently for 0, 5, 10, 15, 20, 25, 30, 35, 40 45, 50, or 55 minutes every hour and then increased continuously (e.g. 60 minutes per hour) when the particle size starts to exceed a target value. The amplitude of the sonication can be combined to adjust the particle size of the product. In one embodiment, the amplitude of the sonication is adjusted in the range of 5% to 100% of the nominal amplitude of the sonicator. In one embodiment, the nominal amplitude varies from 1 to 200 μm. For example, the average D₅₀ particle size of the mixed metal hydroxide product may be maintained at approximately 4 μm by adjusting the duration and amplitude of cavitation. The cavitation process may run for any period of time which yields the desired results, such as for 50, 100, 150, 200, 250, 300, 350, 400 or more hours of time. Target values or sizes of the particles after cavitation may be, for example, 20, 15, 10, 8, 6, 4, 3, 2.5, 2, 1.5, 1, 0.5, 0.1 μm. In one embodiment, the cavitator is a mechanical cavitator that runs at 3600 rpm. In one embodiment, cavitation may take place in a mechanical cavitator at rotation speed 3600 rpm for the first 24 hours. In some embodiments, a mechanical cavitator may run at a rotation speed of 3000, 2400, 1800, 1200, or 600 rpm. In addition, the cavitator may be an electronic or a mechanical cavitator.

Once cavitation starts at step 107, the process 100 moves to step 115 where oxidizing reaction continues in the reaction slurry under cavitation. In some embodiments, a seed mixed metal hydroxide material may be added to the reaction slurry prior to, concurrently with and/or subsequent to the beginning of the cavitation step 105, 107, or 115. In some embodiments, the reaction slurry does not include a seed mixed metal hydroxide material. In some embodiments, a seed mixed metal hydroxide material is not added to the reaction slurry.

If a determination was made at the decision step 103 that cavitation should be started or applied before combining the liquid with the metals and the oxidant, then the process 100 moves to the step 108 and cavitation is applied on the liquid. Once the cavitation is started, the process 100 moves to a step 110 wherein the liquid is combined with a first metal, a second metal and an oxidant. In some embodiments, the cavitation continues to be applied through step 110. In some embodiments, cavitation is stopped before step 110.

Once the reaction slurry is formed at step 110, the process 100 moves to step 115 to react the first metal, the second metal, and the oxidant together under cavitation. The process 100 then moves to step 120 wherein a reaction slurry is separated to form the product slurry having the metal hydroxide material and a returning slurry having the unreacted materials. The product slurry is then formed at step 121 comprising the mixed metal hydroxide material. Similarly, the returning slurry is obtained from the reaction slurry at a step 123 and including all of the unreacted metals. The mixed metal hydroxide material is separated from the product slurry in step 130 to form the filtrate liquid in step 132 which is returned to step 115. In some embodiments, the mixed metal hydroxide material may be isolated from the reaction slurry by a magnetic separator. In some embodiments, the mixed metal hydroxide material may be separated from the product slurry by a separator. The formation of a mixed metal hydroxide product comprising the mixed metal hydroxide material at step 135 terminates the process 100 at the end step 142.

The returning slurry may be directed to a decision step 125 to determine if the cavitation is performed on the returning slurry. If the answer is NO, the returning slurry will be returned to step 115 directly. If the answer is YES, cavitation will be performed on the returning slurry at step 127. In one embodiment, the unreacted metals will be cleaned up at step 127 and will continue to react with the oxidant in step 115. In one embodiment, product nucleation may take place in step 127 and thereby used a seed generation step of the product.

As mentioned, above, in some embodiments, cavitation is applied to the liquid prior to the formation of the reaction slurry, concurrently with the formation of the reaction slurry, subsequent to the formation of the reaction slurry, and combinations thereof.

In some embodiments, cavitation may be performed by an ultrasonic device, a hydrodynamic cavitation device, and combinations thereof. In some embodiments, cavitation may be performed by uniform cavitation, localized cavitation (e.g., by a probe cavitation device), flow cavitation (e.g., by an external flow-cell), or combinations thereof. In some embodiments, parameters of the cavitation generated (e.g., power, amplitude, and duty cycle) may be adjusted to control the generation rate of fines, the particle size distribution, and/or the particle growth rate.

In some embodiments, cavitation of the reaction slurry generates and separates or aids in the generation and separation of metal hydroxide from an elemental metal, thereby forming a seed mixed metal hydroxide material. In some embodiments, the reaction slurry includes a seed mixed metal hydroxide material. In some embodiments, a seed mixed metal hydroxide material is added to the reaction slurry prior to, concurrently with and/or subsequent to the beginning of the oxidation reaction. In some embodiments, the seed mixed metal hydroxide material is the same or similar composition as the mixed metal hydroxide material. In some embodiments, the seed mixed metal hydroxide material comprises particles of particle size D₅₀ of about, of less than, or of less than about, the product mixed metal hydroxide material. In some embodiments, the reaction slurry does not include a seed mixed metal hydroxide material. In some embodiments, a seed mixed metal hydroxide material is not added to the reaction slurry. In some embodiments, the reaction slurry does comprise a seed mixed metal hydroxide in a range of 20 to 700 g per liter of the reaction slurry.

In some embodiments, cavitation aids in the oxidation of elements within the reaction slurry. In some embodiments, cavitation prevents or aids in preventing the over oxidation of elements (e.g., Mn) within the reaction slurry. In some embodiments, over oxidation to higher oxidation valences may be due to exposure to oxygen in the absence of cavitation. In some embodiments, the oxidation process may be performed under an inert atmosphere (e.g., nitrogen, argon, helium, CO₂) or an atmosphere comprising oxygen.

In some embodiments, cavitation of the reaction slurry prevents or aids in the prevention of layered double hydroxide (LDH) phases in the mixed metal hydroxide material. In some embodiments, LDH phases may reduce the density of mixed metal hydroxide materials. In some embodiments, cavitation of the reaction slurry prevents or aids in the prevention of impurities in the mixed metal hydroxide material. In some embodiments, impurities comprise an anion. In some embodiments, the anion impurity comprises nitrate or sulfate.

In some embodiments, the oxidation process is a co-precipitation process, an environmentally friendly process that does not or does not substantially generate effluent and/or waste product, or wherein the waste product may be recycled, or combinations thereof.

In some embodiments, the oxidation reaction is performed by a batch process, a continuous process, or combinations thereof. For example, in some embodiments, the oxidation reaction is performed in one or more batch reactors, continuous stirred tank reactors (CSTR), cascades thereof, or combinations thereof. In a CSTR configuration, in some embodiments, new mixed metal hydroxide particles are generated (i.e., fines) and external mixed metal hydroxide particles are added into the reaction system.

In some embodiments, the first metal is selected from nickel, manganese, cobalt, aluminum, magnesium, and combinations thereof. In some embodiments, the second metal is selected from nickel, manganese, cobalt, aluminum, magnesium, zirconium, yttrium, titanium, vanadium, molybdenum, and combinations thereof. In some embodiments, the second metal may be selected from an elemental metal, a metal alloy, a metal oxide, an ionic metal (e.g., a metal hydroxide), or combinations thereof. In some embodiments, the first metal and second metal are different metals. In some embodiments, the ionic metal is selected from a metal hydroxide, a metal nitrate, and combinations thereof.

In some embodiments, the liquid comprises water. In some embodiments, the liquid may be a newly formed liquid or a recycled liquid from a previously performed oxidation process. In some embodiments, the oxidant is selected from oxygen, air comprising oxygen, nitric acid, hydrogen peroxide, and combinations thereof. In some embodiments, the oxidant may be pure or substantially pure oxygen gas, a gas comprising oxygen (e.g., air), an oxygen producing compound, or combinations thereof.

In some embodiments, the reaction slurry further comprises a dopant material comprising a dopant. In some embodiments, the dopant material may be selected from an elemental metal, a metal alloy, a metal oxide, an ionic metal, or combinations thereof. In some embodiments, the reaction slurry further comprises an additive. In some embodiments, the additive is a salt comprising an anion and a cation. In some embodiments, the salt increases the electrical conductivity of the reaction slurry. In some embodiments, the anion is selected from borate, bromide, iodide, chloride, sulphate, formate, acetate, nitrate, and combinations thereof. In some embodiments, the cation is selected from sodium, potassium, lithium, ammonium, and combinations thereof.

In some embodiments, the reaction slurry comprises a pH of, of about, of at least, or of at least about, 6, 7, 7.5, 8, 8.5, 9, 9.5, 10, 10.5, 11, 11.5, 12, 12.5, 13, 13.5 or 14, or any range of values therebetween. In some embodiments, the reaction slurry further comprises a pH modifier. In some embodiments, the pH modifier is selected from an acid, a base, or combinations thereof. In some embodiments, the acid is selected from sulphuric acid, nitric acid, acetic acid, or combinations thereof. In some embodiments, the base is selected from lithium hydroxide, lithium oxide, sodium hydroxide, sodium oxide, potassium hydroxide, potassium oxide, ammonia, and combinations thereof. In some embodiments, the reaction slurry further comprises a complexing agent. In some embodiments, the complexing agent is selected from ammonia, ammonium, and combinations thereof.

In some embodiments, the temperature of the reaction slurry is, is about, is at least, or is at least about, 20° C., 25° C., 30° C., 35° C., 40° C., 50° C., 60° C., 70° C., 80° C., 90° C., 95° C., 100° C., 110° C., 120° C., 130° C. or 150° C., or any range of values therebetween.

In some embodiments, the mixed metal hydroxide material is isolated from the product slurry and thereby forming a filtrate liquid. In some embodiments, the filtrate liquid is recycled. In some embodiments, the filtrate liquid is recombined (i.e., recycled) with the reaction slurry of the same oxidation process reactor or a different oxidation process or reactor, or a combination thereof. In some embodiments, the filtrate liquid may include ion or elements of at least one of the first metal, the second metal, the oxidant, the solvent, the dopant material, the additive, the pH modifier, a seed mixed metal hydroxide material, and combinations thereof.

In some embodiments, the filtrate liquid comprises one or more starting materials. In some embodiments, the starting material is selected from the first metal, the second metal, the oxidant, the solvent, the dopant material, the additive, the pH modifier, and combinations thereof. In some embodiments, the starting material is selected from the first metal, the second metal, the dopant material, and combinations thereof. In some embodiments, one or more starting materials are separated from the reaction slurry and/or filtrate liquid. In some embodiments, the separated starting material is recombined (i.e., recycled) with the reaction slurry of the same oxidation process reactor or a different oxidation process or reactor, or a combination thereof. In some embodiments, the separated starting material (e.g., first metal, second metal) is separated by magnetic separation. In some embodiments, the separated starting material is treated (e.g., reactivated). In some embodiments, treatment is selected from milling, washing, and combinations thereof. In some embodiments, washing is performed with a solution comprising nitric acid, ammonia, or combinations thereof. In some embodiments, cavitation prevents the deposition of mixed metal hydroxide material on one or more starting materials (e.g., first metal, second metal). In some embodiments, the separated first metal and/or second metal do not or do not substantially comprise a coating, such as an oxidized material or mixed metal hydroxide coating (e.g., oxidized metal coating). As such, in some embodiments, the separated starting material is not treated prior to being recycled.

### Mixed Metal Hydroxide Material

In some embodiments, the mixed metal hydroxide material is selected from a metal oxide, a metal hydroxide, and combinations thereof. In some embodiments, the mixed metal hydroxide material does not or does not substantially comprise a layered double hydroxide (LDH) phase (e.g., the mixed metal hydroxide material comprises less than 10% of a layered double hydroxide (LDH) phase). In some embodiments, the mixed metal hydroxide does not comprise a visible detectable LDH phase by XRD or does not comprise a LDH phase of more than 10%. In some embodiments, the mixed metal hydroxide material comprises less than 5% of a layered double hydroxide (LDH) phase. In some embodiments, the mixed metal hydroxide material comprises less than 1%, 2%, 3%, 4%, 5%, 6%, 7%, 8%, 9%, or 10%, or any range of values therebetween of a layered double hydroxide (LDH) phase. In some embodiments, the mixed metal hydroxide material is free or is substantially free of impurities (e.g., a nitrate impurity, a sulfate impurity). In some embodiments, the mixed metal hydroxide material comprises a tapped density of, of about, of at least, or of at least about, 0.8 g/cm³, 0.9 g/cm³, 1.1 g/cm³, 1.2 g/cm³, 1.3 g/cm³, 1.4 g/cm³, 1.5 g/cm³, 1.6 g/cm³, 1.7 g/cm³, 1.9 g/cm³, 2 g/cm³, 2.1 g/cm³, 2.2 g/cm³, 2.5 g/cm³ or 3 g/cm³, or any range of values therebetween.

In some embodiments, the oxidation process comprising cavitation may produce a plurality of mixed metal hydroxide material particles. In some embodiments, the produced particles comprise a D₅₀ size of, of about, of at most, or of at most about, 0.1 μm, 0.5 μm, 0.8 μm, 1 μm, 1.5 μm, 2 μm, 2.3 μm, 2.5 μm, 2.8 μm, 3 μm, 3.1 μm, 3.2 μm, 3.3 μm, 3.4 μm, 3.5 μm, 3.6 μm, 3.7 μm, 3.8 μm, 3.9 μm, 4 μm, 4.5 μm, 5 μm, 6 μm, 7 μm, 8 μm, 9 μm, 10 μm, 11 μm, 12 μm, 14 μm, 15 μm, 16 μm, 18 μm, 20 μm, 25 μm, or 30 μm, or any range of values therebetween. In some embodiments, the produced particles comprise a SPAN (i.e., (D₉₀−D₁₀)/D₅₀) of, of about, of at most, or of at most about, 0.4, 0.5, 0.6, 0.7, 0.8, 0.9, 1, 1.1, 1.2, 1.3, 1.4, 1.5, 1.6, 1.7, 1.8, 1.9, 2.2, 2.5 or 3.0, or any range of values therebetween. In some embodiments, the mixed metal hydroxide material has primary particles and secondary particles. In some embodiments, the mixed metal hydroxide material has a BET (Brunauer-Emmett-Teller) surface area of, of about, of at least, of at least about, 0.5 m²/g, 1 m²/g, 3 m²/g, 5 m²/g, 10 m²/g, 20 m²/g, 50 m²/g, 100 m²/g, 150 m²/g, 200 m²/g, 250 m²/g, 300 m²/g, 400 m²/g or 500 m²/g, or any range of values therebetween.

### Cathode Active Material and Process

Active materials may be produced from the mixed metal hydroxide material products of the oxidation process described herein. The mixed metal hydroxide may be first pre-baked at a temperature such as 200° C., 300° C., 400° C., 500° C., 600° C., 700° C. or any range of values therebetween to form a mixed metal oxide. In some embodiments, the mixed metal hydroxide material or its pre-baked form, i.e., the mixed metal oxide is combined with a lithium source to form a final mixture, and the final mixture is calcinated to form an active material. In some embodiments, calcination is performed at a temperature of, of about, of at least, or of at least about, 500° C., 600° C., 700° C., 800° C., 900° C., 1000° C., 1100° C., 1200° C. or 1300° C., or any range of values therebetween. In some embodiments, calcination further comprises exposing the final mixture to an oxidant (e.g., oxygen). In some embodiments, the lithium source comprises a compound selected from lithium hydroxide, lithium carbonate, and combinations thereof.

In some embodiments, the active material is milled. In some embodiments, the active material is surface treated. In some embodiments, the surface treatment is selected from washing and/or coating the active material. In some embodiments, the active material is calcined again after its surface is treated. In some embodiments, the active material is calcined again after it is coated by compounds of nickel, manganese, cobalt, aluminum, magnesium, zirconium, yttrium, titanium, vanadium, molybdenum, boron and combinations thereof. In some embodiments, compounds may include metal, oxides, hydroxides, and any form containing the elements or their combinations.

### Electrode Films and Electrodes

An electrode includes an electrode film disposed over a current collector. In some embodiments, the current collector is a foil. In some embodiments, the current collector is aluminum foil, a copper foil, or combinations thereof. In some embodiments, the electrode film is disposed on each side of the current collector. In some embodiments, the electrode is a double-sided electrode including two electrode films disposed on opposite sides of the current collector. In some embodiments, the electrode is mixed with lithium metal and/or lithium ions.

A “wet” electrode, “wet process” electrode, or slurry electrode, is an electrode or comprises an electrode film prepared by at least one step involving a slurry of active material(s), binder(s), and optionally additive(s), even if a subsequent drying step removes moisture from the electrode or electrode film. Thus, a wet electrode or wet electrode film will include at least one or more processing solvents, processing solvent residues, and/or processing solvent impurities. In some embodiments, the electrode film can be a wet processed electrode film. In some embodiments, the electrode film is prepared by a wet or slurry-based electrode fabrication process.

In some embodiments, the electrode film can be a dry processed electrode film. In some embodiments, the electrode film is prepared by a dry electrode fabrication process. As used herein, a dry electrode fabrication process can refer to a process in which no or substantially no solvents are used to form a dry electrode film. For example, components of the active layer or electrode film, including carbon materials and binders, may comprise, consist of, or consist essentially of dry particles. The dry particles for forming the active layer or electrode film may be combined to provide a dry particle active layer mixture.

In some embodiments, the electrode film includes an active material. In some embodiments, the electrode film further comprises at least one binder. In some embodiments, the electrode film comprises the active material in an amount of, of about, of at least, or at least about, 70 wt. %, 75 wt. %, 80 wt. %, 81 wt. %, 82 wt. %, 83 wt. %, 84 wt. %, 85 wt. %, 86 wt. %, 87 wt. %, 88 wt. %, 89 wt. %, 90 wt. %, 91 wt. %, 92 wt. %, 93 wt. %, 94 wt. %, 95 wt. %, 96 wt. %, 97 wt. %, 98 wt. %, 99 wt. % or 100 wt. %, or any range of values therebetween.

In some embodiments, the electrode film includes active cathode material. In some embodiments, cathode active materials can comprise, for example, a mixed metal hydroxide, a metal oxide, metal sulfide, a lithium metal oxide, or combinations thereof. The mixed metal hydroxide material can include, for example, nickel, manganese, cobalt, aluminum, magnesium, zirconium, yttrium, titanium, vanadium, molybdenum and combinations thereof. The lithium metal oxide can be, for example, a lithium nickel manganese cobalt oxide (NMC), a lithium manganese oxide (LMO), a lithium iron phosphate (LFP), a lithium cobalt oxide (LCO), a lithium titanate (LTO), and/or a lithium nickel cobalt aluminum oxide (NCA). In some embodiments, cathode active materials can comprise, for example, a layered transition metal oxide (such as LiCoO2 (LCO), Li (NiMnCo)O2 (NMC) and/or LiNi0.8Co0.15Al0.05O2 (NCA)), a spinel manganese oxide (such as LiMn2O4 (LMO) and/or LiMn1.5Ni0.5O4 (LMNO)), an olivine (such as LiFePO4), silicon, silicon oxide (SiOx), aluminum, tin, tin oxide (SnOx), manganese oxide (MnOx), molybdenum oxide (MoO2), molybdenum disulfide (MoS2), nickel oxide (NiOx), or copper oxide (CuOx). The cathode active material can comprise sulfur or a material including sulfur, such as lithium sulfide (Li2S), or other sulfur-based materials, or a mixture thereof.

In some embodiments, the electrode film includes an anode active material. In some embodiments, anode active materials can include, for example, an insertion material (such as carbon, graphite, and/or graphene), an alloying/dealloying material (such as silicon, silicon oxide, tin, and/or tin oxide), a metal alloy or compound (such as Si—Al, and/or Si—Sn), and/or a conversion material (such as manganese oxide, molybdenum oxide, nickel oxide, and/or copper oxide). The anode active materials can be used alone or mixed together to form multi-phase materials (such as Si—C, Sn—C, SiOx-C, SnOx-C, Si—Sn, Si—SiOx, Sn—SnOx, Si—SiOx-C, Sn—SnOx-C, Si—Sn—C, SiOx-SnOx-C, Si—SiOx-Sn, or Sn-SiOx-SnOx). Anode active materials include common natural graphite, synthetic or artificial graphite, surface modified graphite, spherical-shaped graphite, flake-shaped graphite and blends or combinations of these types of graphite, metallic elements and its compound as well as metal-C composite for anode.

In some embodiments, the electrode film comprises a carbon material configured to reversibly intercalate lithium ions. In some embodiments, the electrode film comprises the carbon material in a total amount of, of about, of at most, or at most about, 20 wt. %, 15 wt. %, 10 wt. %, 9 wt. %, 8 wt. %, 7 wt. %, 6 wt. %, 5 wt. %, 4 wt. %, 3 wt. %, 2 wt. %, 1 wt. %, or any range of values therebetween. In some embodiments, the lithium intercalating carbon is selected from a graphitic carbon, graphite, hard carbon, soft carbon and combinations thereof. For example, the electrode film of the electrode can include a binder material, one or more of graphitic carbon, graphite, graphene-containing carbon, hard carbon and soft carbon, and an electrical conductivity promoting material.

In some embodiments, the electrode film includes a conductive additive. In some embodiments, the conductive additive may comprise a conductive carbon additive. In some embodiments, the conductive carbon additive comprises a carbon black, carbon nanotubes, such as single-walled carbon nanotubes (SWCNTs) and multi-walled carbon nanotubes (MWCNTs). In some embodiments, the electrode film comprises the conductive additive in a total amount of, of about, of at most, or at most about, 10 wt. %, 9 wt. %, 8 wt. %, 7 wt. %, 6 wt. %, 5 wt. %, 4 wt. %, 3 wt. %, 2 wt. %, 1 wt. %, 0.5 wt. %, 0.25 wt. %, 0.1 wt. %, or any range of values therebetween. In some embodiments, each of the conductive additive is in an amount of, of about, of at most, or at most about, 10 wt. %, 9 wt. %, 8 wt. %, 7 wt. %, 6 wt. %, 5 wt. %, 4 wt. %, 3 wt. %, 2 wt. %, 1 wt. %, 0.5 wt. %, 0.25 wt. %, 0.1 wt. %, of the electrode film, or any range of values therebetween. In some embodiments, the conductive additive is carbon black.

In some embodiments, the electrode film includes a binder. In some embodiments, binders can include polytetrafluoroethylene (PTFE), a polyolefin, polyalkylenes, polyethers, styrene-butadiene, co-polymers of polysiloxanes and polysiloxane, branched polyethers, polyvinylethers, a carboxymethylcellulose (CMC), co-polymers thereof, and/or combinations thereof. In some embodiments, the polyolefin can include polyethylene (PE), polypropylene (PP), polyvinylidene fluoride (PVDF), co-polymers thereof, and/or combinations thereof. For example, the binder can include polyvinylene chloride, poly (phenylene oxide) (PPO), polyethylene-block-poly (ethylene glycol), poly (ethylene oxide) (PEO), poly (phenylene oxide) (PPO), polyethylene-block-poly (ethylene glycol), polydimethylsiloxane (PDMS), polydimethylsiloxane-coalkylmethylsiloxane, co-polymers thereof, and/or combinations thereof. In some embodiments, the binder may include a thermoplastic. In some embodiments, the binder comprises, consists essentially, or consists of PVDF. In some embodiments, the electrode film comprises a binder in an amount of, of about, of at most, or at most about, 20 wt. %, 19 wt. %, 18 wt. %, 17 wt. %, 16 wt. %, 15 wt. %, 14 wt. %, 13 wt. %, 12 wt. %, 11 wt. %, 10 wt. %, 9 wt. %, 8 wt. %, 7 wt. %, 6 wt. %, 5 wt. %, 4 wt. %, 3 wt. %, 2 wt. %, 1 wt. %, 0.5 wt. %, 0.25 wt. %, 0.1 wt. %, or any range of values therebetween.

### Energy Storage Systems

An energy storage system or energy storage device includes a positive electrode (i.e., cathode), a negative electrode (i.e., anode), a separator disposed therebetween, and an electrolyte positioned within a housing. Each electrode includes an electrode film disposed over a current collector. The electrode films may include active materials (e.g., cathode active materials, cathode active materials comprising a mixed metal hydroxide material, anode active materials).

In some embodiments, the energy storage device comprises an anode electrode positioned between two cathode electrodes. In some embodiments, the energy storage device is selected from the group consisting of a cylindrical energy storage device, a stacked prismatic energy storage device, and a spiral-wound prismatic energy storage device. In some embodiments, the energy storage device is a battery. In some embodiments, the energy storage device is a lithium-ion battery. In some embodiments, the energy storage devices may be a battery, capacitor, capacitor-battery hybrid, fuel cell, or combinations thereof. In some embodiments, the energy storage system or energy storage device may be used for electromobility. In some embodiments, the energy storage device may be used in motor vehicles, including hybrid electric vehicles (HEV), plug-in hybrid electric vehicles (PHEV), and/or electric vehicles (EV). In some embodiments, the energy storage device used in motor vehicles, including hybrid electric vehicles (HEV), plug-in hybrid electric vehicles (PHEV), and/or electric vehicles (EV) reduces greenhouse gas emissions.

In some embodiments, the energy storage device is charged with a suitable lithium-containing electrolyte. For example, the energy storage device can include a lithium salt, and a solvent, such as a non-aqueous or organic solvent. Generally, the lithium salt includes an anion that is redox stable. In some embodiments, the anion can be monovalent. In some embodiments, a lithium salt can be selected from lithium hexafluorophosphate (LiPF₆), lithium bis(trifluoromethanesulfonyl)imide (LiFSI), lithium tetrafluoroborate (LiBF₄), lithium perchlorate (LiClO₄), lithium bis(trifluoromethansulfonyl)imide (LiN(SO₂CF₃)₂), lithium trifluoromethansulfonate (LiSO₃CF₃), lithium bis(oxalato) borate (LiB(C₂O₄)₂), lithium bis(fluorosulfonyl)imide (LiN(SO₂F)₂, lithium difluoro (oxalato) borate (LiC₂BF₂O₄) and combinations thereof. In some embodiments, the electrolyte can include a quaternary ammonium cation and an anion selected from the group consisting of hexafluorophosphate, tetrafluoroborate and iodide. In some embodiments, the salt concentration can be about 0.1 mol/L (M) to about 5 M, about 0.2 M to about 3 M, or about 0.3 M to about 2 M. In further embodiments, the salt concentration of the electrolyte can be about 0.7 M to about 2 M. In certain embodiments, the salt concentration of the electrolyte can be about 0.2 M, about 0.3 M, about 0.4 M, about 0.5 M, about 0.6 M, about 0.7 M, about 0.8 M. about 0.9 M, about 1 M, about 1.1 M, about 1.2 M, 1.3M, 1.4M, 1.5M or values therebetween.

In some embodiments, an energy storage device can include a liquid solvent. The solvent need not dissolve every component, and need not completely dissolve any component, of the electrolyte. In further embodiments, the solvent can be an organic solvent. In some embodiments, a solvent can include one or more functional groups selected from dioxathiolane (e.g., 1,3,2-dioxathiolane-2,2-dioxide (i.e., “DTD”)), carbonates, ethers and/or esters. In some embodiments, the solvent can comprise a carbonate. In further embodiments, the carbonate can be selected from cyclic carbonates such as, for example, ethylene carbonate (EC), propylene carbonate (PC), vinyl ethylene carbonate (VEC), vinylene carbonate (VC), fluoroethylene carbonate (FEC), and combinations thereof, or acyclic carbonates such as, for example, dimethyl carbonate (DMC), diethyl carbonate (DEC), ethyl methyl carbonate (EMC), and combinations thereof. In some embodiments, one or more solvents can be used at a concentration of, of about, of at least, or at least about, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. % or 90 wt. %, or any range of values therebetween. In some embodiments, solvents are utilized as additives in the electrolyte system, and can be used at a concentration of, of about, of at most, or at most about, 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2 wt. %, 2.1 wt. %, 2.2 wt. %, 2.3 wt. %, 2.4 wt. %, 2.5 wt. %, 2.6 wt. %, 2.7 wt. %, 2.8 wt. %, 2.9 wt. %, 3 wt. %, 4 wt. %, 5 wt. %, 6 wt. %, 7 wt. %, 8 wt. %, 9 wt. % or 10 wt. %, or any range of values therebetween. For example, in some embodiments, the amount of an additive in the electrolyte is or is about in any one of the following ranges: 0.1-10 wt. %, 1-6 wt. %, 2-5 wt. %, 0.1-6 wt. %, 2-8 wt. %, 2-3 wt. %, or 1-4 wt. %.

### EXAMPLES

### Example 1

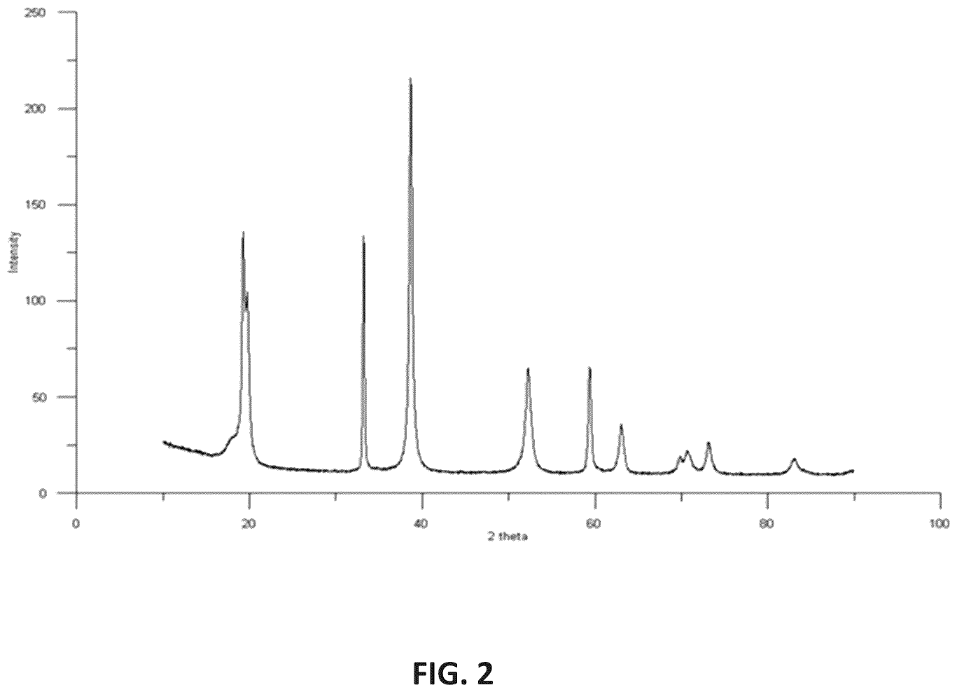

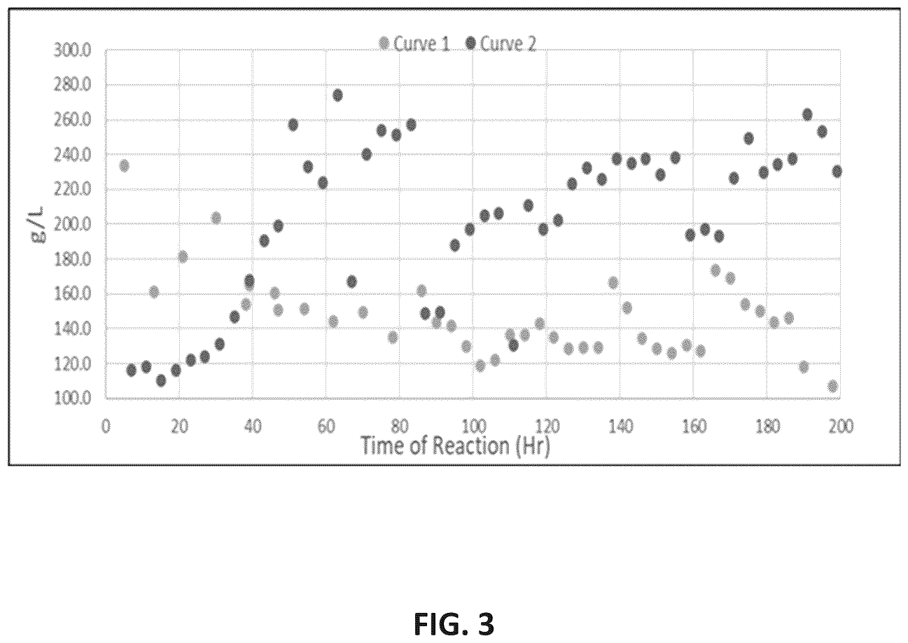

A 1 L flask vessel was fully submerged in an ultrasonic water bath. An aqueous solution of about 0.7 L was recycled into the flask vessel equipped with an overhead mixer. The recycled solution contained 0.7M of sodium sulfate, 0.5M of sodium hydroxide, and 1M of ammonium nitrate. The pH was adjusted and controlled to 9 at 60° C. by adding 28% ammonium slurry. The seeds used for startup were prepared by ball milling of 50 g nickel hydroxide with average particle size under 2 μm after ball milling. The reaction was initiated by adding the ball milled seeds and 100 g of metallic nickel powder sequentially. Cavitation generated by the ultrasonic water bath was applied intermittently to the reaction system at the beginning of the reaction. Nitric acid with a concentration of 68% was introduced into the reaction vessel continuously with a peristaltic pump, meanwhile mixed metals with Ni:Co:Mn of 90:5:5 molar ratio were continuously introduced into the reaction vessel. Nitrogen gas was also introduced into the reaction system with a flow rate of 50 mL/min. The tap density of the mixed metal hydroxide product was achieved around 1.7 g/cm³ when D₅₀ reached about 4 μm. The mixed metal hydroxide product was analyzed by XRD and layered double hydroxide (LDH) phases were not detected, as shown in FIG. 2. The unreacted metallic powder in the reaction slurry was maintained under of about 110 g/L, 120 g/L, 140 g/L, 160 g/L, 180 g/L, or 200 g/L or any range of values therebetween during the reaction, as shown in Curve 1 of FIG. 3. The results of Example 1 are summarized in Table 1 herein.

### Comparative Example 1

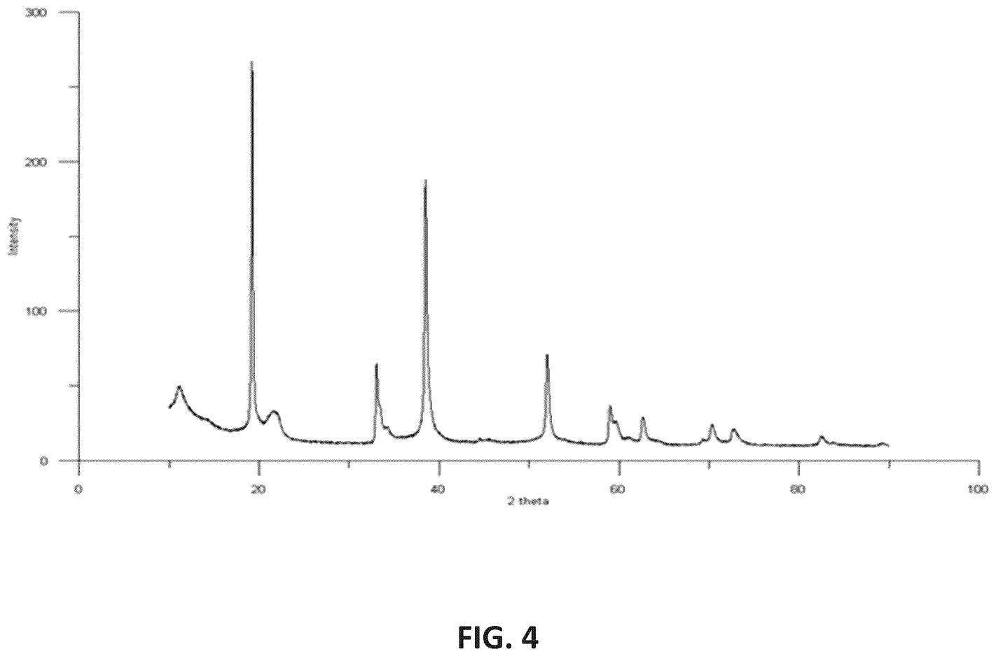

The experimental procedure of Example 1 was performed, except the reaction was performed without cavitation. The tap density of the mixed metal hydroxide product was achieved around 0.8 g/cm³ when D₅₀ reached to about 4 μm. The mixed metal hydroxide product was analyzed by XRD and significant amounts of layered double hydroxide (LDH) phases were detected, as shown in FIG. 4. The unreacted metallic powder in the reaction slurry was above 200 g/L during the majority duration of the reaction, as shown in Curve 2 of FIG. 3. The results of Comparative Example 1 (“Comp. 1”) are summarized in Table 1 herein.

### Example 2

The experimental procedure of Example 1 was performed, except the reaction was performed without external seeds added into the reaction system, and no nitrogen gas was introduced into the reaction system. The tap density of the mixed metal hydroxide product was achieved around 1.7 g/cm³ when D₅₀ reached to about 4 μm. The mixed metal hydroxide product was analyzed by XRD and layered double hydroxide (LDH) phases were not detected. The unreacted metallic powder in the reaction slurry was maintained under 200 g/L during the reaction. The results of Example 2 are summarized in Table 1 herein.

### Example 3

A 3 L reaction glass vessel was equipped in an ultrasonic bath with an overhead mixer and temperature-controlled heating system to simulate one-stage continuous stirred tank reactor (CSTR) operation. About 2.2 L of an aqueous solution, the filtrate, collected from a previous test was transferred to the reaction vessel, containing 0.7M of sodium sulfate, 0.5M of sodium hydroxide, and 1M of ammonium nitrate. The solution was agitated at a stir speed of 700 rpm, while it was heated to a temperature of 65° C. The pH of the solution was adjusted and controlled to 9.9 at 65° C. by adding 28% ammonium hydroxide solution. Once the target temperature was reached, 270 grams of metallic nickel was added into the reaction vessel after 5 minutes of activation time outside of the reactor, and 250 ml of the aqueous solution was used for activation purposes with the same concentrations mentioned above. After about 5 minutes, 1080 grams of a mixed hydroxide with a D₅₀ around 3.6 μm was introduced into the reaction vessel as a seed material. As the reaction began, 68% of nitric acid was pumped into the reactor at 4.7 mL/hr flow rate along with 17 g/hr of mixed metal powder added to match the targeted throughput. To control the rate of nucleation and growth of particles, cavitation by sonication was initially performed for 30 minutes every hour and increased to 60 minutes per hour when particle size began exceeding the target. The average D₅₀ particle size of the mixed metal hydroxide product was maintained around 4 μm by adjusting cavitation duration during the one-stage CSTR operation with a reaction time of 300 hours. The tap density of the mixed metal hydroxide product was achieved around 1.7-1.9 g/cm³. The SPAN (i.e., SPAN=(D₉₀−D₁₀)/D₅₀) of the mixed metal hydroxide product particles was between about 1.3-1.6. The results of Example 3 are summarized in Table 1 herein.

### Example 4

A cascaded batch stage reaction was performed in a first stage followed by a CSTR stage reaction in a second stage. In the first stage, an aqueous solution of about 2.7 L was prepared and transferred into a 3 L reaction vessel equipped with an overhead mixer, temperature-controlled heating system and ultrasonic water bath. The aqueous solution contained 0.7M of sodium sulfate, 0.5M of sodium hydroxide, and 1M of ammonium nitrate. The solution was agitated at a stir speed of 700 rpm, while the solution was heated to a temperature of 65° C. The pH was adjusted and controlled to 9.5 at 65° C. by adding 28% ammonium hydroxide solution. About 220 g of metallic nickel was added into the reaction vessel to initiate the reaction and persistent sonic cavitation was applied from time zero. Nitric acid with a concentration of 68% was introduced into the reaction vessel continuously with a peristaltic pump, and metal powder with Ni:Co:Mn of 90:5:5 molar ratio was continuously introduced into the reaction vessel with a rate of 12.8 g/hr. The pumping rate of nitric acid was about 2.93 mL/hr to match target throughput. The reaction was carried on until an average D₅₀ particle size of about 2.5 μm was achieved. The reaction slurry was filtered to provide a final solid portion, which was washed and collected in the form of a wet cake filtrate, which was used in the second stage CSTR reaction.

The second stage reaction was performed with about 2.4 L filtrate from the first stage recycled and transferred into a 3 L reaction vessel. The solution was agitated at a stir speed of 700 rpm, while the solution was heated to a temperature of 65° C. 300 g of a metal hydroxide powder with a Ni:Co:Mn ratio of 90:5:5 was added into reaction vessel as seeds. 220 g of metallic nickel was added into reaction vessel to initiate the reaction. Nitric acid with a concentration of 68% was introduced into the reaction vessel continuously with a peristaltic pump, and 12.8 g of blended metal powders with Ni:Co:Mn of 90:5:5 were continuously introduced into the reaction vessel. The pumping rate of nitric acid was about 2.93 mL/hr to maintain a constant level of nitrate concentration in the system. Sonic cavitation was applied for 15 minutes every hour.

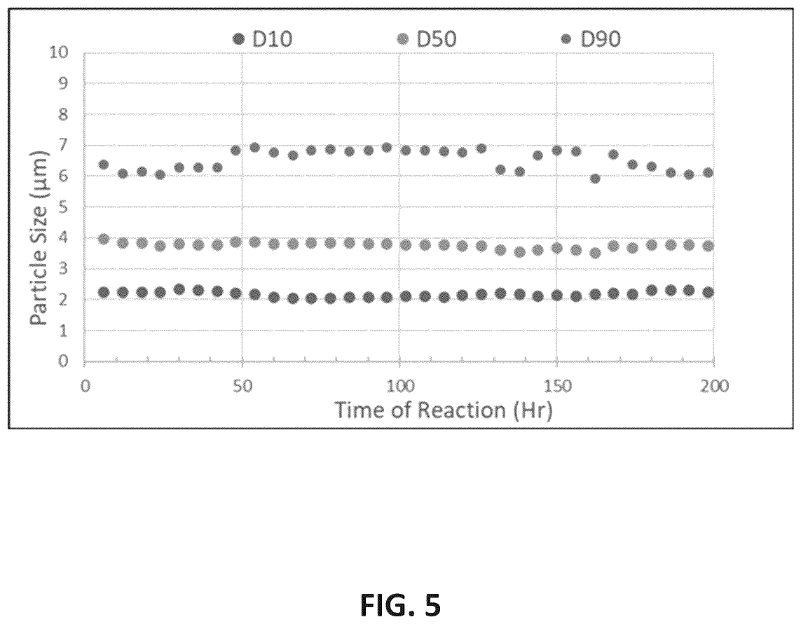

Every six hours, about 250 mL of the slurry from the reaction vessel was collected and the unreacted metals were returned to the reaction vessel. After filtration, the filtrate and the wash water were returned to the reaction vessel to maintain the volume of reaction slurry. When the particles of hydroxide reached around 4 μm D₅₀, about 36.5 grams of about 2.5 μm product from stage 1 was added to the reaction slurry. The operations were repeated continuously to produce mixed metal hydroxide with a D₅₀ of about 4 μm. The tap density of the mixed metal hydroxide product was achieved around 1.8-2.0 g/cm³. The SPAN of the metal hydroxide product was maintained between 1-1.3. FIG. 5 shows a stable particle size distribution with this cascaded batch and CSTR configuration in a 200-hour operation period. The results of Example 4 are summarized in Table 1 herein.

### Example 5

Two cascading CSTR stage reactions were performed. In the first stage, a 10 L stainless reaction vessel was used as the first reactor in the two-stage CSTR operation and to produce mixed hydroxide materials. About 7.4 L of an aqueous solution was prepared in the vessel with 0.7M of sodium sulfate, 0.5M of sodium hydroxide, and 1M of ammonium nitrate. The solution was agitated at a stirring speed of 450 rpm with two impellers and heated to a temperature of 60° C. The pH was adjusted and controlled to 9.7 at 60° C. by adding 28% ammonium hydroxide solution. After the aqueous solution was prepared, 750 g of metallic nickel was added into the reaction vessel to initiate the reaction and ultrasonic power was directly introduced to the slurry by a sonication probe with a 22 mm tip size, which was mounted on the lid of the vessel. After 4 hours of reaction time, mixed metal power was added every hour with a composition of Ni:Co:Mn at a 90:5:5 molar ratio while introducing 68% nitric acid at 8.151 mL/hr flow rate. The particle size distribution was effectively controlled by adjusting pulse duty cycle in the range of 20-100% such that D₅₀ was maintained between 1-3 μm for more than 400 hours of reaction time. The morphology of product particles was spherical and densified. As a result, a product particle tap density of 1.5 g/cm³ was achieved with a D₅₀ around 1.4 μm.

In a second stage, two 3 L reaction glass vessels were set up for a second CSTR reaction. About 2.2 L of aqueous solution collected from a previous test was transferred to the reaction vessel, containing 0.7M of sodium sulfate, 0.5M of sodium hydroxide, and 1M of ammonium nitrate. The solution was agitated at a stirring speed of 700 rpm, while the solution was heated to a temperature of 60° C. The pH was adjusted and controlled to 10 at 60° C. by adding 28% ammonium hydroxide solution. Once the target temperature was reached, 270 g of metallic nickel was added into the reaction vessel after 5 minutes of activation time outside of the reactor, and 250 mL of aqueous solution was used for the activation purpose with the same concentration as mentioned above. After about 5 minutes, 1080 grams of nickel, manganese cobalt hydroxide was introduced into the reaction vessel as a seed material, with a material size of about 3.6 μm D₅₀. As the reaction began, 68% of nitric acid was pumped into the reactor at 2.9 mL/hr flow rate along with 10.7 g/hr of mixed metal powder Ni:Co:Mn at a 90:5:5 molar ratio. For CSTR control in the second stage, the mixed metal hydroxide collected from the first stage reactor was used with feeding rate equivalent to about 12.5 wt. % of the overall throughput. D₅₀ was maintained around 4 μm. A tap density of the mixed metal hydroxide product was about 1.8-1.9 g/cm³ throughout the test, and the SPAN of the metal hydroxide product was maintained between 1.0-1.3. The results of Example 5 are summarized in Table 1 herein.

### Example 6

A mechanical cavitator with a rotating disc was connected to a 100 L stainless reaction vessel through a pumped cycle loop. An aqueous solution was prepared in the 100 L vessel with 0.7M of sodium sulfate, 0.5M of sodium hydroxide, and 1M of ammonium nitrate. The solution was agitated at a stirring speed of about 200 rpm with two impellers and heated to a temperature of 65° C. The pH was adjusted and controlled to 10 at 65° C. by adding 28% ammonium hydroxide solution. After the aqueous solution was prepared, about 10 kg of metallic nickel was added into the reaction vessel to initiate the reaction, and the mechanical cavitator was started at 60 Hz. After about 1 hour of reaction time, a mixed metal power was added every hour with a 90:5:5 molar ratio of Ni:Co:Mn while 68% nitric acid was introduced. Nitrogen gas was also introduced into the reaction system with a flow rate of 2 L/min. The tap density of the mixed metal hydroxide product was achieved around 1.8 g/cm³ when the D₅₀ reached to about 3.3 μm. The unreacted metallic powder was well maintained under 200 g/L as desired during the operation. The results of Example 6 are summarized in Table 1 herein.

### Example 7

Similar to Example 6, a test with oxygen as the oxidant was performed in a 100 L stainless reaction vessel assisted by mechanical cavitation. An oxygen injection line was connected in the circulation loop and pre-mixed with slurry before entering the mechanical cavitator. An aqueous solution was prepared in the 100 L vessel with 0.5M of sodium sulfate and 0.075M of ammonium sulfate. The solution was agitated at a stirring speed of 225 rpm with two impellers and heated to a temperature of 60° C. The pH was adjusted and controlled to 10 at 60° C. by adding 28% ammonium hydroxide solution. After the aqueous solution was prepared, about 10 kg of metallic nickel was added into the reaction vessel for activation until a redox potential dropping to −600 mv was achieved. The reaction was triggered by continuously introducing oxygen with a flow rate of 1.57 L/min, and the mechanical cavitator was started at 60 Hz. The nickel hydroxide nuclei were formed under 60 Hz mechanical cavitation in the first 24 hours. Then, the mechanical cavitator was adjusted to 20 Hz to promote particle growth. The tap density of the nickel hydroxide particles was achieved around 1.6 g/cm³ when the D₅₀ reached to about 2.0 μm. Identical to Example 6, the unreacted metallic powder was well maintained under 200 g/L as desired during operation.

TABLE 1

| | Example | | | | | | | |
|---|---|---|---|---|---|---|---|---|
| | 1 | Comp. 1 | 2 | 3 | 4 | 5 | 6 | 7 |
| Operation | Batch | Batch | Batch | 1 Stage | Batch + | 2 Stage | Batch | Batch |
| mode | | | | CSTR | CSTR | CSTR | | |
| Cavitation | Sonication | No | Sonication | Sonication | Sonication | Sonication | Mechanical | Mechanical |
| Applied | | | | | | | | |
| Seeding | Yes | Yes | No | Yes | No | No | No | No |
| for startup | | | | | | | | |
| Nitrogen | Yes | Yes | No | Yes | Yes | Yes | Yes | No |
| applied | | | | | | | | |
| Tapped | 1.7 | 0.8 | 1.7 | 1.7-1.9 | 1.8-2 | 1.8-1.9 | 1.8 | 1.6 |
| density | | | | | | | | |
| (g/cm³) | | | | | | | | |
| SPAN | 0.78 | 0.66 | 0.67 | 1.3-1.6 | 1-1.3 | 1-1.3 | 0.89 | 0.8-0.9 |
| LDH phase | No | Yes | No | — | — | — | — | — |
| Metal | Good | Poor | Good | Good | Good | Good | Good | Good |
| Activity | | | | | | | | |

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the components for an energy storage system described herein can be provided separately, or integrated together (e.g., packaged together, or attached together) to form an energy storage system.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount, depending on the desired function or desired result.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. A method of producing a mixed metal hydroxide material, comprising:
combining a first metal, a second metal, an oxidant and a liquid to form a reaction slurry;
applying cavitation to the reaction slurry;
reacting the first metal, the second metal and the oxidant to form a product slurry comprising a mixed metal hydroxide material;
wherein the mixed metal hydroxide material comprises the first metal and the second metal; and
wherein the first metal and the second metal are different metals.

2. The method of claim 1, wherein the cavitation is applied to the liquid prior to the formation of the reaction slurry.

3. The method of claim 1, wherein the cavitation is applied to the liquid when the liquid is part of the reaction slurry.

4. The method of claim 1, wherein the cavitation is applied by a device selected from the group consisting of an ultrasonic device, a hydrodynamic cavitation device, and combinations thereof.

5. The method of claim 1, wherein the reaction slurry does not comprise a seed mixed metal hydroxide material.

6. The method of claim 1, wherein the mixed metal hydroxide material comprises less than 10% of a layered double hydroxide (LDH) phase.

7. The method of claim 1, wherein the mixed metal hydroxide material comprises a tapped density of at least 1 g/cm³.

8. The method of claim 1, wherein the mixed metal hydroxide material comprises a SPAN of at most about 2 in particle size distribution value.

9. The method of claim 1, wherein the mixed metal hydroxide material is substantially free of a nitrate impurity, a sulfate impurity, a sulfur impurity, or combinations thereof.

10. The method of claim 1, wherein the reaction slurry comprises a pH of at least about 7.

11. The method of claim 1, wherein the first metal is selected from the group consisting of nickel, manganese, cobalt, aluminum, magnesium and combinations thereof.

12. The method of claim 1, wherein the second metal is selected from the group consisting of nickel, manganese, cobalt, aluminum, magnesium, zirconium, yttrium, titanium, vanadium, molybdenum and combinations thereof.

13. The method of claim 1, wherein the oxidant is selected from the group consisting of oxygen, air comprising oxygen, nitric acid, hydrogen peroxide, and combinations thereof.

14. The method of claim 1, further comprising forming a final mixture comprising the mixed metal hydroxide material and a lithium source and calcinating the final mixture to form an active material for use in a battery electrode.

15. The method of claim 14, further comprising forming the active material into a cathode.

16. The method of claim 15, further comprising making an energy storage device using the cathode, an anode and an electrolyte.

17. The method of claim 16, wherein making the energy storage device comprises making an electric vehicle energy storage device.

18. A mixed metal hydroxide material for use as an active material precursor, comprising:
a first metal;
a second metal; and
a tapped density of at least 1 g/cm³;
wherein the first metal and the second metal are different metals; and
wherein the mixed metal hydroxide material comprises less than 10% of a layered double hydroxide phase.

19. An energy storage system, comprising:
a cathode made from the active material formed by the method of claim 14;
an anode;
a separator positioned between the cathode and the anode;
an electrolyte; and
a housing, wherein the cathode, the anode, and the electrolyte are disposed within the housing.

20. The energy storage system of claim 19, wherein the energy storage system is an electric vehicle energy storage system.
